(19) United States
(12) Patent Application Publication
(10) Pub. No.: US 2010/0042421 A1
(43) Pub. Date: Feb. 18, 2010

(54) CONTEXT BASED ADVERTISEMENT BIDDING MECHANISM

(75) Inventors: Tian Bai, Beijing (CN); Eric I. Chang, Beijing (CN); Raman Chandrasekar, Seattle, WA (US); Michael Tsang, Beijing (CN)

Correspondence Address: PERKINS COIE LLP/MSFT, P. O. BOX 1247, SEATTLE, WA, 98111-1247, US

(73) Assignee: Microsoft Corporation, Redmond, WA (US)

(21) Appl. No.: 12/193,652

(22) Filed: Aug. 18, 2008

(51) Int. Cl. G06Q 30/00; G06Q 40/00; G06Q 90/00

(52) U.S. Cl. 705/1; 705/37; 705/14.53; 705/14.64

(57) ABSTRACT

A software and/or hardware facility for managing online advertisement bidding processes is described. The facility selects advertisements for delivery to mobile device users based on advertiser bids. The advertisers may bid for presentation of their advertisements to users having certain spatio-temporal, user segment, and/or other characteristics. The facility may also select advertisements for delivery based on an estimated likelihood of a mobile device user's positive response to the advertisement. Advertiser and user feedback may also be employed to refine the process of selecting advertisements for delivery.

### BACKGROUND

The increasing popularity of electronic communications is changing the way advertisers communicate with their audiences. In particular, advertising emphasis is shifting from traditional advertisements (e.g., print, television, billboard, etc.) to online advertising. Online advertising presents opportunities for targeting advertisements to receptive audiences and may result in increased acceptance of advertisements, higher clickthrough rates, and increased sales. Targeted advertisements may also result in increased revenue for advertisers and/or advertisement service providers (ASP).

Likewise, mobile communications services such as wireless telephony, wireless data services, and wireless email are being increasingly used for both business and personal purposes. Mobile communication services now provide real-time or near real-time delivery of electronic communications and network access over large geographical areas. The increasing popularity of mobile communications services presents additional advertising opportunities.

### SUMMARY

A software and/or hardware facility for managing online advertisement bidding processes is described. The facility selects advertisements for delivery to mobile device users based on advertiser bids. The advertisers may bid for presentation of their advertisements to users having certain spatio-temporal, user segment, and/or other characteristics. The facility may also select advertisements for delivery based on an estimated likelihood of a mobile device user's positive response to the advertisement. Advertiser and user feedback may also be employed to refine the process of selecting advertisements for delivery.

This Summary is provided to introduce a selection of concepts in a simplified form that are further described in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 illustrates a suitable environment for practicing aspects of the invention.

FIG. 2 illustrates a system for managing online advertisement bidding processes.

FIG. 3 is a logical flow diagram of a process for managing online advertisement bidding processes.

FIGS. 4A-4D illustrate examples of advertisements that may be presented to users.

### DETAILED DESCRIPTION

A software and/or hardware facility for managing online advertisement bidding processes is described. The facility selects advertisements for delivery to mobile device users based on advertiser bids. The advertisers may bid for presentation of their advertisements to users having certain spatio-temporal, user segment, and/or other characteristics. The facility may also select advertisements for delivery based on an estimated likelihood of a mobile device user's positive response to the advertisement. Advertiser and user feedback may also be employed to refine the process of selecting advertisements for delivery.

The facility may be employed to increase advertisement service providers (ASP) and/or advertiser revenue by providing a mechanism to advertisers for targeting advertisements to likely interested parties while decreasing the number of advertisements provided to likely uninterested parties. This may enable advertisers to provide, for example, spatio-temporally relevant advertisements to users predisposed to be interested in the advertisement. These users may be more likely to open the advertisement, read the advertisement, interact with the advertisement, make a purchase based on the advertisement, and/or the like, if the advertisement is relevant to their present or future location or situation. Accordingly, advertisements targeted in this manner may be more effective, and advertisers may be willing to pay increased advertising fees for them.

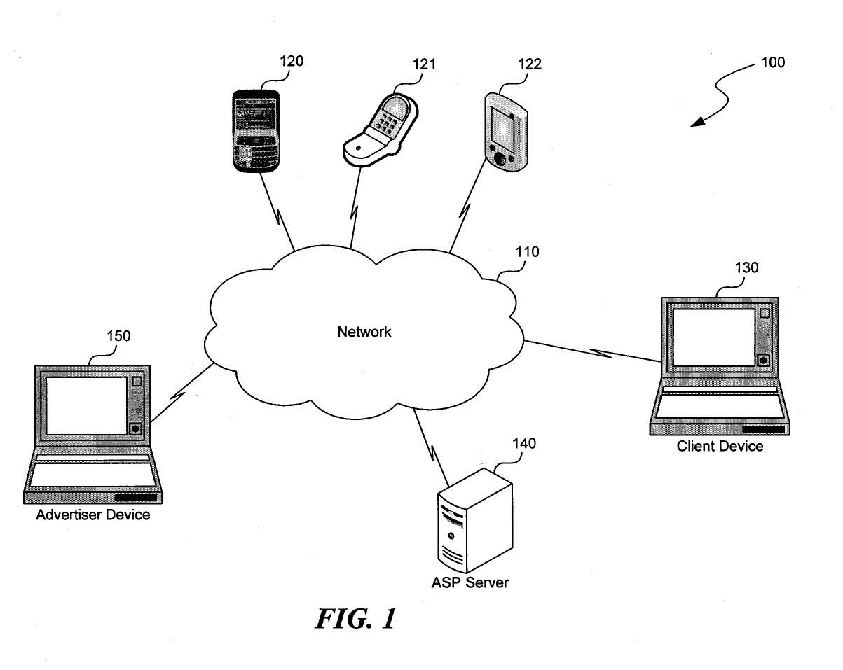

FIG. 1 illustrates a suitable environment in which aspects of the invention may be practiced. However, various modifications, such as the inclusion of additional devices, consolidation and/or deletion of various devices, and the shifting of functionality from one device to another, may be made without deviating from the invention. Environment 100 includes network 110, mobile devices 120-122, client device 130, ASP server 140, and advertiser device 150.

Network 110 is configured to interconnect various computing devices such as mobile devices 120-122, client device 130, ASP server 140, and advertiser device 150 to each other and to other resources. In addition, network 110 may include any number of wired and/or wireless networks, including the Internet, intranets, local area networks (LANs), metropolitan area networks (MANs), personal area networks (PANs), wide area networks (WANs), direct connections, and/or the like. Additional computing devices such as routers, network switches, hubs, modems, firewalls, gateways, Radio Network Controllers (RNCs), proxy servers, access points, base stations, and/or the like may be employed to facilitate communications.

Further, the various computing devices may be interconnected with T1 connections, T3 connections, OC3 connections, frame relay connections, Asynchronous Transfer Mode (ATM) connections, microwave connections, Ethernet connections, token-ring connections, Digital Subscriber Line (DSL) connections, and/or the like. In addition, network 110 may also utilize any wireless standard and/or protocol. These include, for example, Global System for Mobile Communications (GSM), Time Division Multiple Access (TDMA), Code Division Multiple Access (CDMA), Orthogonal Frequency Division Multiple Access (OFDM), General Packet Radio Service (GPRS), Enhanced Data GSM Environment (EDGE), Universal Mobile Telecommunications System (UMTS), Advanced Mobile Phone System (AMPS), Worldwide Interoperability for Microwave Access (WiMAX), Wireless Fidelity (WiFi), and/or the like.

Mobile devices 120-122 may include virtually any portable computing devices capable of receiving and sending messages over a network, such as network 110. Such devices include portable devices such as cellular telephones, display pagers, radio frequency (RF) devices, infrared (IR) devices, Personal Digital Assistants (PDAs), handheld computers, laptop computers, wearable computers, tablet computers, integrated devices combining two or more of the preceding devices, and/or the like. As such, mobile devices 120-122 range widely in terms of capabilities and features. For example, a cellular telephone may have a numeric keypad and the capability to display only a few lines of text. However, other cellular telephones (e.g., smart phones) may have a touch-sensitive screen, a stylus, and a relatively high-resolution display.

Mobile devices 120-122 may typically include a processing unit, volatile memory and/or nonvolatile memory, a power supply, one or more network interfaces, an audio interface, a display, a keypad or keyboard, a Global Positioning System (GPS) receiver and/or other location determination device, and other input and/or output interfaces. Also, the various components of mobile devices 120-122 may be interconnected via a bus.

The volatile and nonvolatile memories generally include computer storage media for storing information such as computer readable instructions, data structures, program modules, or other data. Some examples of information that may be stored include basic input/output systems (BIOS), operating systems, and applications. In addition, the memories may be employed to store operational data, content, contexts, and/or the like.

The memories may also store one or more client applications that are configured to receive, forward, and/or provide content, such as advertisements, from and/or to another computing device. Content may also be displayed and/or stored on mobile devices 120-122. The content may include advertisements contained within short message service (SMS) messages, multimedia message service (MMS) messages, instant messaging (IM) messages, enhanced message service (EMS) messages, and/or any advertisements or other content directed toward a user of mobile devices 120-122, such as audio data, multimedia data, photographs, video data, still images, text, graphics, animation files, voice messages, and text messages. The memories may also store one or more client applications that are configured to provide advertisement targeting information to other computing devices and/or to enable a user to respond to an advertisement (e.g., redeem a coupon, interact with an advertisement, reject an advertisement, etc.).

Mobile devices 120-122 may also provide identifiers to other computing devices. These identifiers may include identification of a type, capability, and/or name of each particular mobile device. In one embodiment, mobile devices 120-122 may uniquely identify themselves and/or identify a group association through any of a variety of mechanisms, including a phone number, a Mobile Identification Number (MIN), an electronic serial number (ESN), a Media Access Control (MAC) address, a personal identification number (PIN), an RF signature, and/or other identifier.

Client device 130 may include virtually any computing device capable of communicating over a network. Typically, client device 130 is a computing device such as a personal computer (PC), multiprocessor system, microprocessor-based or programmable consumer electronic device, and/or the like. In addition, client device 130 may be a television, digital video recorder, media center device, set-top box, other interactive television device, and/or the like. Also, client device 130 may store and/or execute client applications with the same or similar functionality as those stored on the memories of mobile devices 120-122. For example, client device 130 may store one or more client applications that are configured to provide advertisement targeting information to other computing devices and/or to enable a user to respond to an advertisement. In certain instances, advertisements may be delivered to a mobile device user at client device 130 instead of on a mobile device.

ASP server 140 may include any computing device capable of connecting to network 110 to provide advertisements to users of mobile devices 120-122 and/or client device 130. ASP server 140 may also be configured to manage an online advertisement bidding process. Devices that may operate as ASP server 140 include personal computers, desktop computers, multiprocessor systems, microprocessor-based or programmable consumer electronic devices, servers, and/or the like. Likewise, ASP server 140 may include a single computing device; the functionality of ASP server 140 may be distributed across multiple computing devices; or ASP server 140 may be integrated into another device such as an SMS gateway, an advertisement server, and/or the like.

Advertiser device 150 may include virtually any computing device capable of communicating over a network. Typically, advertiser device 150 is a computing device such as a personal computer, multiprocessor system, microprocessor-based or programmable consumer electronic device, and/or the like. Also, advertiser device 150 may be utilized by an advertiser to provide advertisements and/or other information to ASP server 140 and/or mobile devices 120-122 and/or to interact with a user following advertisement responses (e.g., to complete a sale, to register a user, to provide information, etc.). Also, advertiser device 150 may be configured to operate as a merchant platform (e.g., an online merchant web server, point-of-sale cash register or terminal, network-enabled vending machine, inventory management system, telephone sales system, etc.). In addition, advertiser device 150 may also be employed to provide information corresponding to advertisements, such as targeting information, advertising budget, advertising campaign characteristics, advertiser information, and/or the like to ASP server 140.

Additional details regarding mobile devices 120-122, client device 130, ASP server 140, advertiser device 150, and the functionalities thereof are discussed below.

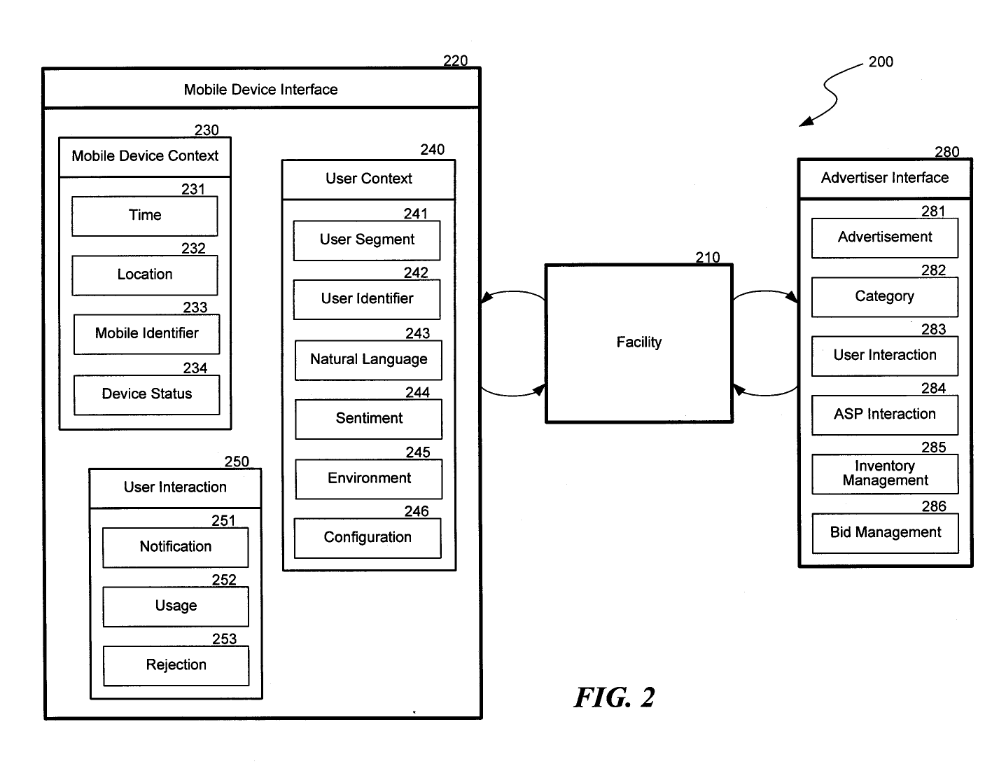

FIG. 2 illustrates online advertisement bid management system 200. As illustrated, system 200 includes facility 210, configured to receive inputs from multiple sources and multiple input sources. The input sources may include mobile device interface 220 and advertiser interface 280. For clarity, system 200 and the functionalities thereof are described below as being performed by particular elements of environment 100 of FIG. 1. However, system 200 and the functionalities thereof may also be, for example, performed by or on other processors, elements, or devices whether or not such processors, elements, or devices are described herein.

Facility 210 may include a software and/or hardware facility for selecting advertisements for delivery to a user. For example, facility 210 may provide advertisements, such as coupons, to a mobile device user and enable the user to redeem the coupon.

Facility 210 may be implemented on any device. For example, facility 210 may be implemented on ASP server 140 and configured to receive inputs from mobile devices 120-122, client device 130, and/or advertiser device 150. However, facility 210 may also be implemented on and/or configured to receive input from any other suitable device. Likewise, the illustrated input sources are provided merely to illustrate some of the many possible input sources for such a facility. In other systems, other, different, fewer, and/or additional inputs may also be suitably employed.

Mobile device interface 220 may be provided to enable facility 210 to receive input from, and to communicate with, a mobile device. As illustrated, mobile device interface 220 includes mobile device context component 230, user context component 240, and user interaction component 250. In one example, mobile device interface 220 may be implemented on mobile devices 120-122 or client device 130. However, mobile device interface 220 may also be implemented on ASP server 140, advertiser device 150, and/or any other suitable device.

Mobile device interface 220 may employ either “push” or “pull” technologies to communicate with facility 210. For example, mobile device interface 220 may push context information to facility 210 on a continuous, periodic, or nonperiodic basis. Likewise, facility 210 may push advertisements to mobile device interface 220 based on received context information, and/or mobile device interface 220 may request, with or without context information, an advertisement, such as a coupon. In one example, a user may request a certain category of coupon (e.g., a dining coupon) from facility 210 via mobile device interface 220.

Mobile device context component 230 may be configured to provide any characteristics of a mobile device useful for targeting advertisements. As shown, mobile device context component 230 includes time module 231, location module 232, mobile identifier module 233, and device status module 234. However, mobile device context component 230 may include other modules.

Time module 231 may be employed to determine the current time and/or to measure durations of time. Time module 231 may include a clock, a timer, or a component to determine time from a broadcast time signal, a GPS signal, or any other time source. For example, time information may be employed by itself or in conjunction with other information to determine whether message delivery is currently appropriate (e.g., during daytime hours, while the user is not in a business meeting, etc.).

Location module 232 may be employed, for example, to determine the location of mobile device 120. The location of mobile device 120 may be determined by GPS, triangulation from broadcast tower signals and/or WiFi access point signals, manual entry by a user, schedule information, or any other location determination technique. This location information may be employed to provide geographically relevant advertisements, such as coupons, notifications, and/or offers. In addition, location information may further include speed and/or directional information relating to the mobile device. For example, speed and/or directional information may be employed to determine whether message delivery is currently appropriate and/or to provide geographically relevant advertising at a predicted destination and/or along a predicted route.

Mobile identifier module 233 may be employed to provide any useful mobile identifier to facility 210. For example, mobile identifiers may include device identifiers discussed above with respect to FIG. 1.

Device status module 234 may also be employed to provide device status information to facility 210. In one example, device status information includes a status of mobile device 120, such as whether mobile device 120 is currently employed for processing a voice telephone call, Internet browsing, processing email, playing music or video, and/or the like. Likewise, device status information may also include whether the mobile device is in a wireless communications service area, what the signal strength of a wireless communications signal is, whether peripheral devices (e.g., data storage devices, input/output devices, etc.) are connected, and/or the like.

User context component 240 may be configured to provide real-time, near real-time, and/or non-real-time user context characteristics to facility 210 that may be useful for targeting advertisements and/or selectively providing advertisements that are relevant to, for example, a user's mood, environment, or tasks. As shown, user context component 240 includes user segment module 241, user identifier module 242, natural language module 243, sentiment module 244, environment module 245, and configuration module 246.

User segment module 241 may be provided to identify characteristics of a user and/or group of users. For example, user segment module 241 may be employed to identify a group of users that share any one or more characteristics. Such characteristics may include geographic characteristics (e.g., location, population density (urban, semi-urban, rural), climate, etc.); demographic characteristics (e.g., age, gender, family size, education, income, occupation, socioeconomic status, religion, ethnicity, language, etc.); and/or behavioral characteristics (e.g., product usage rate, brand loyalty, readiness to buy, income status, etc.).

Any population of individuals may be divided into two or more segments by facility 210, such that the characteristics of each group association may provide information that is useful to target advertisements to users in that particular segment. These characteristics may also be determined through information received from a user, received from a third party, and/or inferred through a user's use of a mobile device. Although illustrated as within mobile device interface 220, user segment module 241 may also be integrated within facility 210.

User identifier module 242 may provide any useful user identifier to facility 210. For example, user identifiers may include usernames or other identifiers corresponding to the user of a mobile device. Facility 210 may also employ a user identifier if a mobile device user uses multiple mobile devices or if multiple users share a single mobile device.

Natural language module 243 and sentiment module 244 are respectively configured to provide natural language and sentiment information to facility 210. As one example, natural language and sentiment information may be based on a user's interaction with or through, for example, mobile device 120, may include textual, speech, and physiological information, and may be extracted from text messages, mobile browser queries, voice messages, telephonic discussions, notes, and/or any other information available to mobile device 120.

In one example, natural language information may be analyzed to determine the subject matter of the mobile device user's interaction with mobile device 120. Likewise, sentiment information may be analyzed to determine the user's emotional state, attitude, needs, or intent. For example, a mood, stress level, workload, and/or the like of the user may be inferred based on analyzing sentiment information. In addition, natural language and/or sentiment information may be analyzed to infer user context and/or user intent.

Natural language and/or sentiment analysis may employ any suitable analysis algorithms, methods, procedures, and/or the like. For example, natural language processing algorithms, voice recognition algorithms, pattern matching algorithms, computational linguistics algorithms, text mining algorithms, semantic analysis algorithms, vector analysis algorithms, and/or the like may be employed to analyze natural language and/or sentiment information. Custom and/or situational-specific vocabularies, libraries, models, and/or the like may also be employed.

Natural language and/or sentiment information may be extracted by mobile device 120 for on-board analysis and/or analysis at client device 130 and/or ASP server 140. However, natural language and/or sentiment information may be extracted at any other suitable computing device, such as ASP server 140, a wireless communications service base station, and/or the like. For example, natural language and/or sentiment information may be extracted by a wireless communications service base station in communication with mobile device 120.

User context module 240 may also include environment module 245 to ascertain or receive environmental information. For example, environmental information may include ambient temperature, body temperature, heart rate, humidity, pressure, current weather, traffic conditions, motion and/or orientation of mobile device 120, proximity to other mobile devices, and/or the like. Mobile device 120 may include various sensors to sense these and other examples of environmental information. However, certain examples of environmental information may be sensed at or by a server and/or provided by a third party. For example, proximity to other mobile devices may be determined at a communications service provider server, and current weather information may be provided by a third-party weather service.

Configuration module 246 may provide configuration information to facility 210. The configuration information may include a user's configurable preferences, configuration settings, configuration data, and/or schedule information. Some examples of suitable configuration information include the hours during which a user is willing to receive advertisements, the user's dietary preferences, the user's typical and/or anticipated travel plans, the user's calendar information and/or other schedule information, and/or the like. Also, calendar and schedule information may include information regarding the user's business meetings, personal meetings, events, task lists, and/or the like.

Configuration module 246 may also be included in and/or provide advertisement targeting information to facility 210 as further discussed in the concurrently filed U.S. patent application entitled “Context Based Online Advertising” by R. Chandrasekar et al., having attorney docket number 418268481 US, the entirety of which is hereby incorporated by reference. Configuration module 246 may also be included in and/or provide advertisement targeting information to facility 210 as further discussed in the concurrently filed U.S. patent application entitled “Context Based Advertisement Filtration” by E. Chang et al., having attorney docket number 418268483US, the entirety of which is hereby incorporated by reference.

Additional preference information may be determined by observing text that a user has entered, past searches that the user has performed, bookmarks that have been saved by the user, messages the user may have sent or received, or other indications of subject matter of interest to the user. For example, mobile device 120 may include a record of the user's pattern of use of certain words, phrases, URLs, etc. As another example, mobile device 120 or ASP server 140 may include a record of purchases made by the user. As yet another example, mobile device 120 may include a record of the user's entertainment media, such as available audio and video media titles that are stored on or accessible via mobile device 120.

User interaction component 250 may also be provided to enable facility 210 to receive input from, and to communicate with, a user. As illustrated, user interaction component 250 includes notification module 251, usage module 252, and rejection module 253. In one example, user interaction component 250 may be implemented on mobile devices 120-122 or client device 130. However, it may also be implemented on ASP server 140, advertiser device 150, and/or any other suitable device.

Facility 210 may employ information received from user interaction component 250 to continuously and/or periodically improve facility 210 by accounting for a user's previous interactions with facility 210. These interactions may be analyzed to define user preferences, identify instances of previous message miscategorization, and improve/refine the accuracy of a message processing algorithm and/or a model of user behavior.

Notification module 251 may be configured to notify a user of an incoming advertisement. For example, notification module 251 may include an email client application, an SMS client application, a really simple syndication (RSS) client application, and/or the like. Notification module 251 may also be selectively configured to notify a user of incoming messages based on the user's context as further discussed in the concurrently filed U.S. patent application entitled “Context Based Advertisement Filtration” as incorporated by reference above.

Usage module 252 may provide usage data indicative of a user's interaction with advertisements. For example, usage data may include whether the user viewed an advertisement, requested further information, made a purchase, saved a message for later viewing, printed an advertisement, and/or the like.

Rejection module 253 may provide information regarding a user's rejection of an advertisement. For example, rejection module 253 may be employed by a user to indicate that an advertisement is unwanted, irrelevant, and/or the like. Rejection module 253 may also be configured to infer a user's response to an advertisement based on either passive or active actions. For example, rejection module 253 may be configured to infer a rejection of an advertisement based on whether the advertisement is deleted without being viewed, is viewed for a short duration, is ignored, and/or the like.

Facility 210 may receive input from, and communicate with, an advertiser via advertiser interface 280. As illustrated, advertiser interface 280 includes advertisement module 281, category module 282, user interaction module 283, ASP interaction module 284, inventory management module 285, and bid management module 286. In one example, advertiser interface 280 may be implemented on advertiser device 150. However, it may also be implemented on mobile devices 120-122, client device 130, ASP server 140, and/or any other suitable device.

Advertisement module 281 may be configured to provide advertisements and other corresponding information to facility 210. Advertisements may include virtually any information that an advertiser presents to an audience in any format or through any medium. Nonlimiting examples of suitable advertisements include coupons, textual advertisements, notifications of upcoming events, notifications of promotions, and/or the like. Also, advertisements may be either commercial or noncommercial in nature. For example, advertisements may be included with and/or intended for electronic delivery via email, SMS messages, MMS messages, and/or the like. However, other delivery methods may also be suitably employed. Advertisement module 281 may also be configured to provide corresponding information to facility 210. Corresponding information may include targeting information, budget information, advertising campaign characteristics, and/or the like.

Category module 282 may be provided to categorize received advertisements by any suitable characteristics, such as the value of the offer (e.g., dollar amount of discount, percentage amount of discount, status as free, lack of discount, etc.), the type of merchandise offered (e.g., food, clothes, electronics, events, etc.), the type of content (e.g., video advertisement, text advertisement, coupon, etc.), the timing of the offer, user-defined categories, and/or the like. Although illustrated as within advertiser interface 280, category module 282 may also be integrated within facility 210.

User interaction module 283 may be configured to enable interaction between an advertiser and users who receive advertisements. For example, advertiser interface 280 may be configured to provide additional information regarding a product and/or service, to conduct transactions with users, to track user responses to advertisements, to collect information regarding users, and/or the like. In one example, user interaction module 283 includes an advertiser's point-of-sale device configured to track redemption of coupons provided in advertisements. However, other devices may also suitably function as user interaction module 283.

ASP interaction module 284 may be configured to enable interaction between an advertiser and an ASP. For example, ASP interaction module 284 may enable communication of advertising budget information, advertisement effectiveness information, advertisement response information, and/or the like, between ASP server 140 and advertiser device 150. In one system, ASP interaction module 284 is configured to provide real-time communications between an ASP and an advertiser. However, in other systems, ASP interaction module 284 may provide delayed communications, batched communications, periodic communications, and/or the like. In one example, facility 210 may employ the information received from ASP interaction module 284 to improve/refine the bidding mechanism of system 200.

Inventory management module 285 may be configured to manage and/or provide inventory information. Likewise, inventory management module 285 may also be configured to receive advertising information (e.g., number of advertisements provided to users, historical redemption rates, expected redemption rate, etc.). For example, inventory management module 285 may be employed to adjust bid prices based on inventory levels and/or to adjust inventory based on anticipated demands.

Bid management module 286 may be configured to provide bids to facility 210, for example, to indicate an advertiser's willingness to pay for delivery of an advertisement, redemption of a coupon, and/or the like. For example, bid management module 286 may calculate a bid as a function of the category of the advertisement, the time at which the advertisement is to be delivered, the location of the user when the advertisement is delivered, a user segment of the user, and/or the like.

Bid management module 286 may also be employed to receive information relating to the effectiveness of the advertiser's or other advertisers' advertisements. This information may include either generic information and/or information specific to an advertiser, advertisement category, particular advertisement, and/or the like. Bid management module 286 may also employ such information to determine bid prices, modify advertisements, cancel advertisements, and/or the like.

In operation, information from these and other modules may be employed to select advertisements for user delivery and/or bid for delivery of an advertisement. For example, facility 210 may operate as a matchmaking system to match advertisements with users who are likely to respond positively to the advertisements.

In one example in which advertisers pay on a cost-per-impression basis, facility 210 may provide coupons to users solely on the basis of bid price. However, if advertisers pay on a cost-per-action basis (e.g., per coupon redemption, per positive indication, based on an advertiser's revenue, etc.), facility 210 may select advertisements as a function of bid prices and advertisement effectiveness. Advertisement effectiveness may be determined based on estimations and/or user feedback to delivered advertisements. Also, advertisement effectiveness may also be based on redemption rates; response rates; discount amount; community-based feedback; the popularity of the advertiser, product, or service; and/or the like.

In one example, a feedback loop may be employed to determine the effectiveness of an advertiser. For example, advertisement identifiers (e.g., unique or non-unique serial numbers, barcodes, coupon codes, tracking numbers, telephone numbers, email addresses, user identifiers, etc.) may be used to determine effectiveness through users' responses to that advertiser's advertisements. As one example, facility 210 may deliver advertisements to users and track responses to the delivered advertisements. The tracked response may be used as feedback to iteratively select additional advertisements.

Facility 210 may also be employed to provide enhanced advertisement targeting capabilities to advertisers. In one example, advertisers may utilize the ability to bid on the various characteristics discussed above, to target advertisements, and to track return on advertisement expenditures. For example, advertisers may provide relatively higher bids for delivery of coupons at certain times (e.g., advertisements for fast food at lunchtime, etc.), to mobile devices within a given targeted area, when relatively more inventory is available, to users belonging in a user segment that is relatively likely to purchase the advertiser's product (e.g., “users who often drink coffee,” “users who often go to XYZ Coffee Shop,” etc.), to users who have previously purchased the advertiser's product, to users who have previously purchased a competitor's product, and/or the like.

The above examples are provided to illustrate the operation of facility 210. However, these examples merely illustrate some of the many possible inputs for facility 210 and some of the many ways in which facility 210 may utilize various inputs to selectively filter messages.

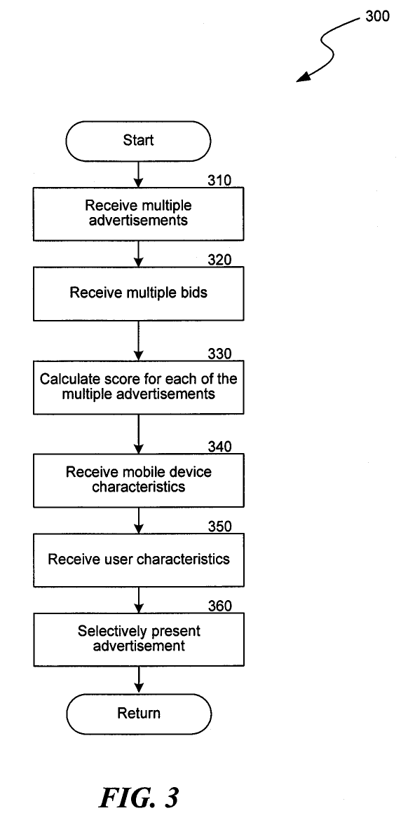

FIG. 3 illustrates process 300 for managing online advertisement bidding processes. Process 300 may be implemented in software, in hardware, or in a combination of hardware and software. As such, the operations illustrated as blocks in FIG. 3 may represent computer-executable instructions which, when executed, direct a system in managing online advertisement bidding processes. For clarity, process 300 is described below as being performed by particular elements of environment 100 of FIG. 1 and system 200 of FIG. 2. However, process 300 may also be performed by other processors, by other elements, or in other systems, whether or not such processors, elements, or systems are described herein. Likewise, process 300 may be a real-time, near real-time, or non-real-time process.

At block 310, facility 210 receives multiple advertisements. For example, facility 210 may receive advertisements from multiple advertisers, each requesting that their advertisement be targeted and presented to a user. However, facility 210 may also receive multiple advertisements from a single advertiser. From block 310, processing flows to block 320.

At block 320, facility 210 receives multiple bids. In one example, each of the multiple bids corresponds to advertisements received at block 310. In addition, each of the bids may include a bid price, mobile device targeting characteristics, user targeting characteristics, category characteristics, and/or the like. For example, mobile device targeting characteristics may include spatio-temporal characteristics such as a time at the mobile device, a location of the mobile device, a speed of the mobile device, any other mobile device context characteristic, and/or the like. User targeting characteristics may also include a user segment, a user identifier, any other user context characteristic, and/or the like. In addition, an advertiser may also adjust and/or determine a bid price based on inventory levels, for example, as determined by inventory management module 285.

In fact, facility 210 may be configured to enable an advertiser to bid on virtually any characteristic for delivery of an advertisement. For example, this may enable an advertiser to bid for and target an advertisement to a particular demographic group, a specific user, specific user characteristics, a specific mobile device, and/or the like. In one example, an advertiser may provide a bid that is a function of an advertisement category, an anticipated delivery time, an anticipated location of the mobile device to which the advertisement is to be delivered, and a targeted user segment. From block 320, processing flows to block 330.

At block 330, facility 210 calculates a score for each of the multiple advertisements. For example, the score may be calculated as a function of the bid price and at least one of mobile device targeting characteristics and/or user targeting characteristics. These characteristics may correspond to mobile device context characteristics and/or user context characteristics that may be provided by mobile device context component 230 and/or user context component 240. However, any other targeting characteristics may also be employed at block 330.

In one example, facility 210 calculates the score at block 330 as a function of the bid price and the effectiveness of the advertisement. Also, the effectiveness of the advertisement may be based on a discount offered by the advertisement. However, as another example, the score may also be calculated based on a mobile identifier characteristic, a device status characteristic, a user identifier characteristic, a user environment characteristic, a user preference characteristic, a user schedule characteristic, and/or the like.

Facility 210 may also calculate the score based on advertisement effectiveness characteristics such as those discussed above with regard to bid management module 286. As one example, calculating the score in this manner may include receiving user feedback corresponding to selectively presented advertisements, determining advertisement effectiveness characteristics based on the received user feedback, and calculating the score based on the determined advertisement effectiveness characteristics. Facility 210 may then selectively present additional advertisements based on the calculated score. For example, this may include providing the same advertisement to another user. From block 330, processing flows to block 340.

At block 340, facility 210 receives mobile device characteristics. The mobile device characteristics may be based on a mobile device context of a mobile device and may be, for example, based on any of the mobile device context characteristics from mobile device context component 230. However, any other suitable mobile device characteristics may also be employed and/or received at block 340. From block 340, processing flows to block 350.

At block 350, facility 210 receives user characteristics. For example, suitable user characteristics may be based on any of the user context characteristics from user context component 240. As one example, facility 210 may also be configured to extract natural language and/or sentiment information from text messages, mobile browser queries, voice messages, telephonic discussions, notes, and/or any other information available to a mobile device as the user characteristics or as part thereof. However, any other suitable user characteristics may also be employed and/or received at block 350. From block 350, processing flows to block 360.

At block 360, facility 210 selectively presents an advertisement. This selective presentation may be based on the calculated score, the received mobile device characteristics, the received user characteristics, and/or the like. For example, facility 210 may continuously, periodically, and/or nonperiodically monitor mobile device and/or user context characteristics to deliver advertisements having corresponding “winning” bids if the mobile device and/or user context characteristics indicate that the context is appropriate for delivery of the advertisement. From block 360, processing returns to other actions. In other examples, from block 360, processing may instead flow to block 310, 320, 330, 340, or 350 to iteratively and selectively present any number of additional advertisements.

Those skilled in the art will appreciate that the blocks shown in FIG. 3 may be altered in a variety of ways. For example, the order of blocks may be rearranged, substeps may be performed in parallel, shown blocks may be omitted, or other blocks may be included, etc.

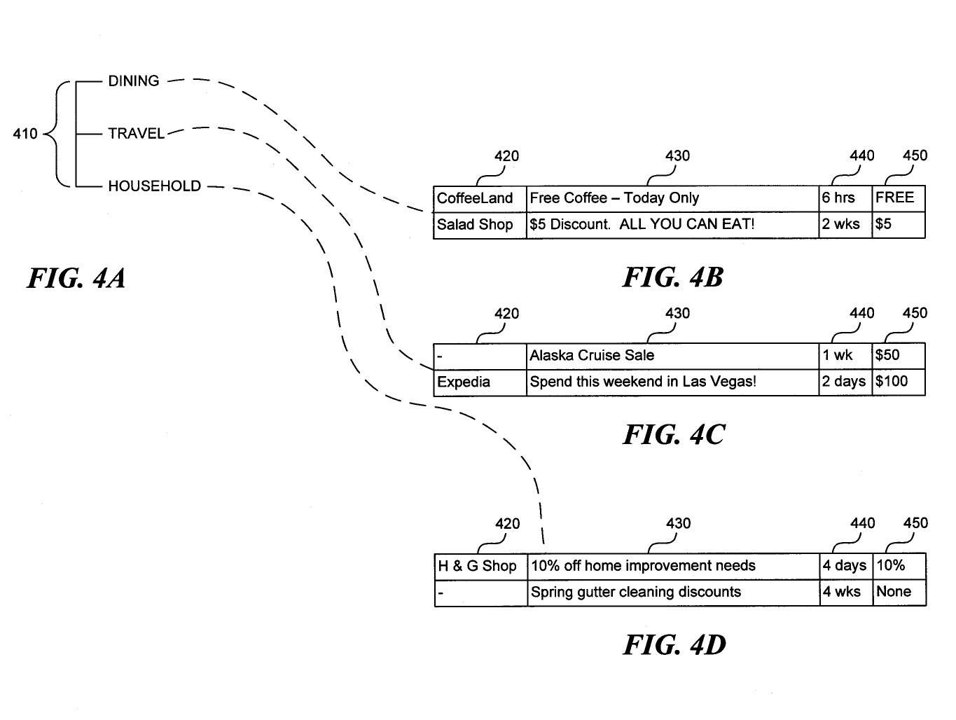

FIGS. 4A-4D illustrate example advertisements that may be presented to users by, for example, facility 210. As shown, FIG. 4A illustrates example advertisement categories. FIG. 4B illustrates exemplary dining advertisements. FIG. 4C illustrates exemplary travel advertisements. Finally, FIG. 4D illustrates exemplary household advertisements. While FIGS. 4A-4D illustrate certain example categories and advertisements, other categories and advertisements may be included. For example, other categories may be included for automotive, housing, and entertainment advertisements.

Each of FIGS. 4B-4D also illustrates sender field 420, subject field 430, expiration field 440, and discount field 450 for the various example advertisements. However, other advertisements may include any number of other fields. For example, a message text field, various flag fields, a received time field, an event time field, and/or the like may also be included.

The above detailed description of embodiments of the system is not intended to be exhaustive or to limit the system to the precise form disclosed above. While specific embodiments of, and examples for, the system are described above for illustrative purposes, various equivalent modifications are possible within the scope of the system, as those skilled in the relevant art will recognize. For example, while processes or blocks are presented in a given order, alternative embodiments may perform routines having steps, or employ systems having blocks, in a different order, and some processes or blocks may be deleted, moved, added, subdivided, combined, and/or modified to provide alternatives or subcombinations. Each of these processes or blocks may be implemented in a variety of different ways. Also, while processes or blocks are at times shown as being performed in series, these processes or blocks may instead be performed in parallel or may be performed at different times. Further, any specific numbers noted herein are only examples, and alternative implementations may employ differing values or ranges. Those skilled in the art will also appreciate that the actual implementation of a database may take a variety of forms, and the term “database” is used herein in the generic sense to refer to any data structure that allows data to be stored and accessed.

We claim:

1. A method for managing online advertisement bidding processes, comprising:
receiving multiple advertisements;
receiving multiple bids, wherein each bid of the multiple bids corresponds to one advertisement of the multiple advertisements, and wherein each bid of the multiple bids includes a bid price and at least one of a mobile device targeting characteristic or a user targeting characteristic;
calculating a score for each of the multiple advertisements as a function of the bid price and at least one of the mobile device targeting characteristic or the user targeting characteristic;
receiving a mobile device characteristic based on a mobile device context of a mobile device;
receiving a user characteristic based on a user context; and
selectively presenting one or more advertisements of the multiple advertisements based on the calculated score, the received mobile device characteristic, and the received user characteristic.

2. The method of claim 1, wherein each bid of the multiple bids includes the bid price, the mobile device targeting characteristic, and the user targeting characteristic, and wherein the function includes the bid price, the mobile device targeting characteristic, and the user targeting characteristic.

3. The method of claim 2, wherein the mobile device targeting characteristic includes a time characteristic and a location characteristic, and wherein the user targeting characteristic includes a user segment characteristic.

4. The method of claim 1, wherein each bid of the multiple bids includes the bid price, a category characteristic, and at least one of the mobile device targeting characteristic or the user targeting characteristic, and wherein the function includes the bid price, the category characteristic, and at least one of the mobile device targeting characteristic or the user targeting characteristic.

5. The method of claim 1, wherein the function includes the bid price, the mobile device targeting characteristic, the user targeting characteristic, and an advertisement effectiveness characteristic.

6. The method of claim 5, wherein the advertisement effectiveness characteristic includes at least one of a redemption rate, response rate, discount amount, community-based feedback, advertiser popularity, product popularity, or service popularity.

7. The method of claim 5, further comprising:
receiving user feedback corresponding to the selectively presented one or more advertisements;
determining the advertisement effectiveness characteristic based on the received user feedback; and
selectively presenting one or more advertisements to another user based on the determined advertisement effectiveness.

8. The method of claim 1, wherein the bid price is based on an advertiser inventory level.

9. The method of claim 1, wherein the function further includes at least one of a mobile identifier characteristic, a device status characteristic, a user identifier characteristic, a user environment characteristic, a user preference characteristic, or a user schedule characteristic.

10. The method of claim 1, wherein receiving the user characteristic includes:
extracting at least one of natural language information or sentiment information.

11. The method of claim 10, wherein extracting at least one of the natural language information or the sentiment information includes:
receiving user speech data; and
extracting at least one of the natural language information or the sentiment information from the received user speech data.

12. A processor-readable medium containing instructions for executing a method of managing online advertisement bidding processes, wherein the method comprises:
receiving multiple advertisements;
receiving multiple bids, wherein each bid of the multiple bids corresponds to one advertisement of the multiple advertisements, and wherein each bid of the multiple bids includes a bid price, a category characteristic, a mobile device targeting characteristic, and a user targeting characteristic;
calculating a score for each of the multiple advertisements as a function of the bid price, the mobile device targeting characteristic, the category characteristic, the user targeting characteristic, and an advertisement effectiveness characteristic;
receiving a mobile device characteristic based on a mobile device context of a mobile device;
receiving a user characteristic based on a user context, including:
receiving user speech data; and
extracting at least one of natural language information or sentiment information from the received user speech data; and
selectively presenting one or more advertisements of the multiple advertisements based on the calculated score, the received mobile device characteristic, and the received user characteristic.

13. The processor-readable medium of claim 12, wherein the mobile device targeting characteristic includes a time characteristic and a location characteristic.

14. The processor-readable medium of claim 12, wherein the user targeting characteristic includes a user segment characteristic.

15. The processor-readable medium of claim 12, wherein the method further comprises:
receiving user feedback corresponding to the selectively presented one or more advertisements;
determining the advertisement effectiveness characteristic based on the received user feedback; and
selectively presenting one or more advertisements to another user based on the determined advertisement effectiveness.

16. The processor-readable medium of claim 12, wherein the advertisement effectiveness characteristic includes at least one of a redemption rate, response rate, discount amount, community-based feedback, advertiser popularity, product popularity, or service popularity.

17. A computing system configured to manage online advertisement bidding processes, comprising:
a memory;
a first module configured, when executed in the memory, to receive multiple advertisements;
a second module configured, when executed in the memory, to receive multiple bids, wherein each bid of the multiple bids corresponds to one advertisement of the multiple advertisements, and wherein each bid of the multiple bids includes a bid price and at least one of a mobile device targeting characteristic or a user targeting characteristic;
a third module configured, when executed in the memory, to calculate a score for each of the multiple advertisements as a function of the bid price and at least one of the mobile device targeting characteristic or the user targeting characteristic;
a fourth module configured, when executed in the memory, to receive a mobile device characteristic based on a mobile device context of a mobile device;
a fifth module configured, when executed in the memory, to receive a user characteristic based on a user context; and
a sixth module configured, when executed in the memory, to selectively present one or more advertisements of the multiple advertisements based on the calculated score, the received mobile device characteristic, and the received user characteristic.

18. The computing system of claim 17, wherein each bid of the multiple bids includes the bid price, a category characteristic, the mobile device targeting characteristic, and the user targeting characteristic, wherein the mobile device targeting characteristic includes a time characteristic and a location characteristic, wherein the user targeting characteristic includes a user segment characteristic, and wherein the function includes the bid price, the category characteristic, the mobile device targeting characteristic, and the user targeting characteristic.

19. The computing system of claim 17, wherein the function includes the bid price, the mobile device targeting characteristic, the user targeting characteristic, and an advertisement effectiveness characteristic.

20. The computing system of claim 17, wherein the fifth module includes:
a seventh module configured, when executed in the memory, to extract at least one of natural language information or sentiment information.
